(19) United States
(12) Patent Application Publication
(10) Pub. No.: US 2003/0233466 A1
(43) Pub. Date: Dec. 18, 2003

(54) System and method for efficient message transport by message queuing middleware

(76) Inventor: Ian Kinkade, Madison, CT (US)

Correspondence Address: PERMAN & GREEN, 425 POST ROAD, FAIRFIELD, CT, 06824, US

(21) Appl. No.: 10/340,365

(22) Filed: Jan. 10, 2003

Related U.S. Application Data
(60) Provisional application No. 60/347,575, filed on Jan. 10, 2002.

(51) Int. Cl. G06F 15/16

(52) U.S. Cl. 709/232

(57) ABSTRACT

A method and system provide for communication of a message between a sender and a receiver by use of message queuing middleware, wherein the sender has a computer with a sender queue manager and operating under a sender application linked to both a sender channel library and a sender application programming interface (API) library, and the receiver has a receiver computer operating under a receiver application and providing the functions of a receiver queue manager and a receiver channel agent dedicated writer that are linked to a receiver API library. Method steps include applying API calls to both remote and local queue managers respectively to the sender channel and API libraries, sending the message to the receiver channel agent, and directing the receiver queue manager to receive API calls from the from the receiver API library and to read the message from a received queue to the receiver application.

### BACKGROUND OF THE INVENTION

This application claims priority from provisional application No. 60/347,575, which is incorporated herein in its entirety.

1. Field of the Invention

The present invention relates to communications between computers and, more particularly, to message queuing middleware.

2. Brief Description of Related Developments

Middleware systems are communications systems for transmitting data messages between computer systems having often incompatible applications and communication methods. Among other functions, the middleware sets and controls the priorities of the data messages. U.S. patent application Ser. No. 09/760,535 discloses some examples of middleware communications systems, the disclosure of which is hereby incorporated by reference. Some of the details disclosed therein may be of interest as to teachings of alternatives to details of the embodiment herein.

An implementation of a middleware system 100 is shown in FIG. 1. When a user application 110 on a sender system 112 transmits a data message to a receiver system 114, the user application 110 employs the middleware's application programming interface (API) library 116 to transfer the data message to the sender system middleware queuing manager 118. The sender system middleware queuing manager 118 transmits the data message over a middleware channel 120 to the receiver system 114. The receiver system 114 includes a middleware queuing manager 122 which receives the data message and processes and forwards the data message with the queuing manager API library 124 to a receiver system 114 user application 126.

Current middleware systems 100, such as IBM MQSeries, are reliable and work well within a local computer 112. However, current middleware systems are very limited in the number of messages in a time period that can be transmitted over a network, such as the internet. This is partially due to a large amount of overhead necessary for handling many operating contingencies, features and options, such as persistent data messaging. A non-persistent message is a message which may not be delivered if one or more of the transmission systems is disabled or not available during the transmission of the message. A persistent message is guaranteed to be delivered to the receiving application. If one or more of the transmission systems is unavailable, the message will be delivered as soon as the systems are available. Such a persistent message will not be lost. The guaranteed delivery of the message is essential for applications such as control processing, where it is necessary to keep a chemical solution in a certain balance, and messages relating to the temperature and composition must be received by the control system. Persistent messaging is also essential in medical systems, where the transmittal of a medical order or an insurance form may be required for timely and proper treatment.

Due to the limitations in transmission speed of the current middleware 100, the middleware 100 is not suited for operating in such environments where a large number of data messages must be transmitted in a short period of time, such as over 30 messages per second. It would be advantageous to have a system which is just as reliable as present middleware systems, but provides more efficient and faster transmission of data messages. It would be further advantageous if the system does not require changes to the user application or the middleware.

### SUMMARY OF THE INVENTION

The present invention is directed to a system for efficient message transport by message queuing middleware. In one embodiment, the system includes a client computer, which includes at least one user application and a channel interface system. The channel interface system includes a data connection to the at least one user application, a selector for associating a data message with a channel interface system, and a transmitter for transmitting the data message via a computer network.

The system also includes a server computer having an interface for receiving the data message via the computer network. The server computer includes a message queuing middleware system, and a channel queuing system for receiving the data message and distributing the data message to the message queuing middleware system.

### BRIEF DESCRIPTION OF THE DRAWINGS

The foregoing aspects and other features of the present invention are explained in the following description, taken in connection with the accompanying drawings, wherein:

FIG. 1 is a block diagram of a middleware system between a sender system and a receiving system.

FIG. 2 is a block diagram of an embodiment of the present invention illustrating a message transport system for improving performance of data message transmission between a sender system and a receiver system.

FIG. 3 is a block diagram of another embodiment of the present invention illustrating a message transport system for improving performance of data message transmission between a sender system and a receiver system.

FIG. 4 is a chart illustrating an improvement in non-persistent messaging efficiency due to an embodiment of the current invention.

FIG. 5 is a chart illustrating an improvement in persistent messaging efficiency due to an embodiment of the current invention.

FIG. 6 is a message flow chart showing operation of the message transport system of FIG. 2 for the case of non-persistent message flow from a single source.

FIG. 7 is a message flow chart showing operation of the message transport system of FIG. 2 for the case of persistent message flow from a single source.

FIG. 8 is a message flow chart showing alternative operation of the message transport system of FIG. 2 for the case of persistent message to multiple target queues.

FIG. 9 is a block diagram showing a system for message transport by message queuing middleware, which may be employed in the construction of the system of FIG. 2.

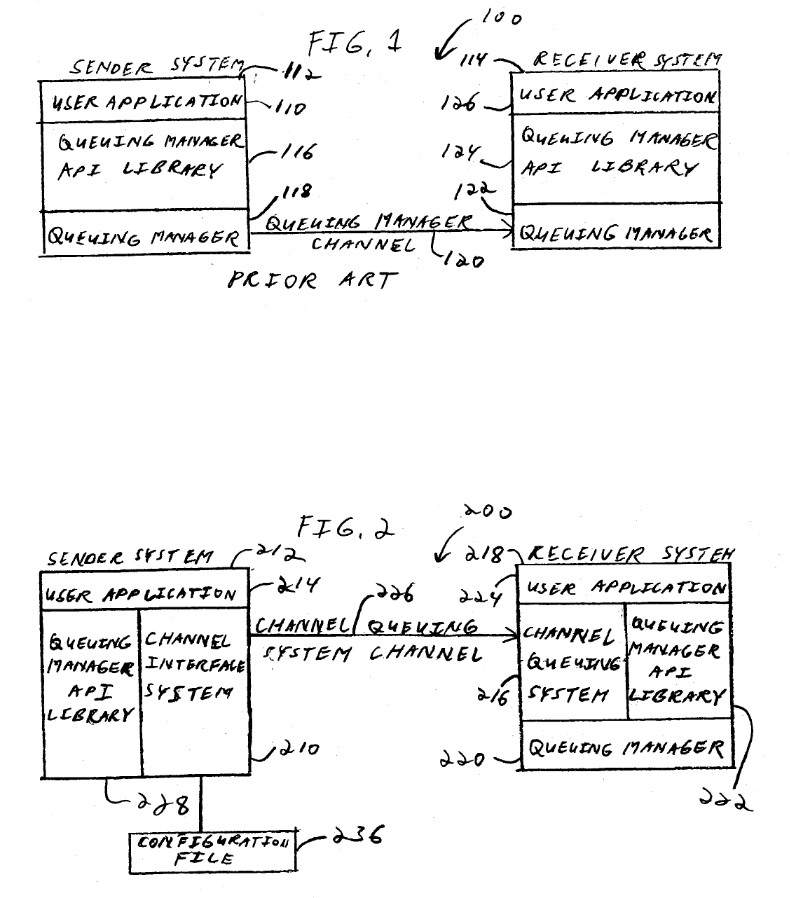

### DETAILED DESCRIPTION OF THE PREFERRED EMBODIMENT(S)

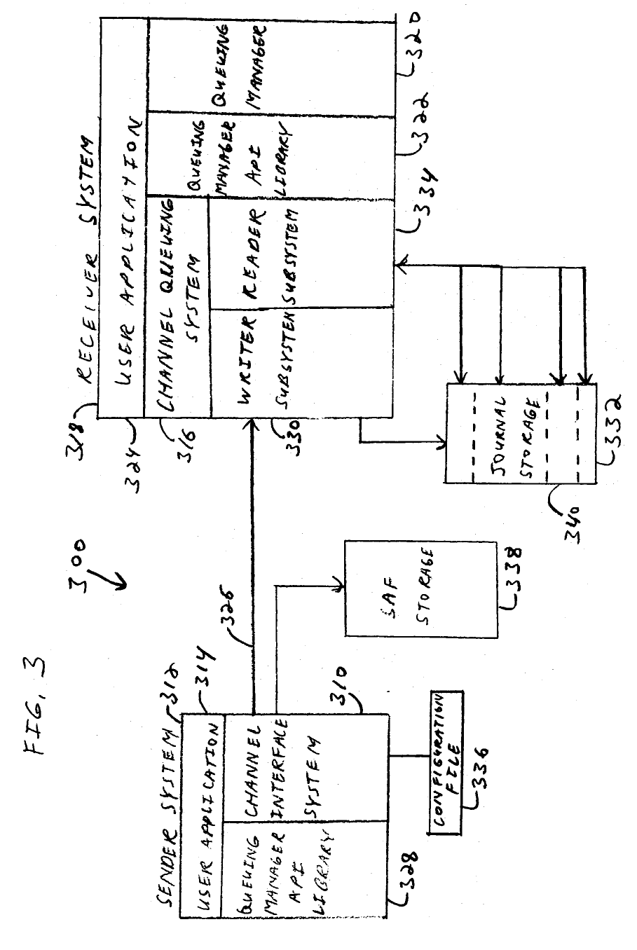

Referring to FIG. 2, there is shown a block diagram view of a message transport system 200 incorporating features of the present invention. Although the present invention will be described with reference to the embodiment shown in the drawings, it should be understood that the present invention can be embodied in many alternate forms of embodiments. In addition, any suitable size, shape or type of elements or materials could be used.

As shown in FIG. 2, the message transport system 200 generally comprises a channel interface system 210 on the sender system 212 for receiving a data message from an user application 214 and transmitting the data message to a channel queuing system 216 on a receiver system 218. The channel queuing system 216 is a standalone component which runs on the same computer system 218 as a middleware queuing manager 220. The channel queuing system 216 replaces some of the functions of the middleware queuing manager 220 with alternative functions which increase the data message throughput speed. The channel queuing system 216 employs the middleware queuing manager API library 222 for passing the data message to the middleware queue manager 220 for further processing and transmission to the user application 224.

On the sender system 212, the user application attempts to transmit the data message to the middleware system by invoking a middleware queuing manager API library 228 procedure on the sender system. The channel interface system 210 intercepts the API invocation, which contains the target queue for the data message. If the target queue is not listed in a configuration file 236, the channel interface system 210 continues by invoking the middleware system and passing the data message to the middleware system. If the target queue of the data message is listed in the configuration file 236, the channel interface system 210 transmits the data message to the channel queuing system 216 on the receiver system 218 through an interface channel 226. The interface channel 226 substitutes for a channel used by the middleware system.

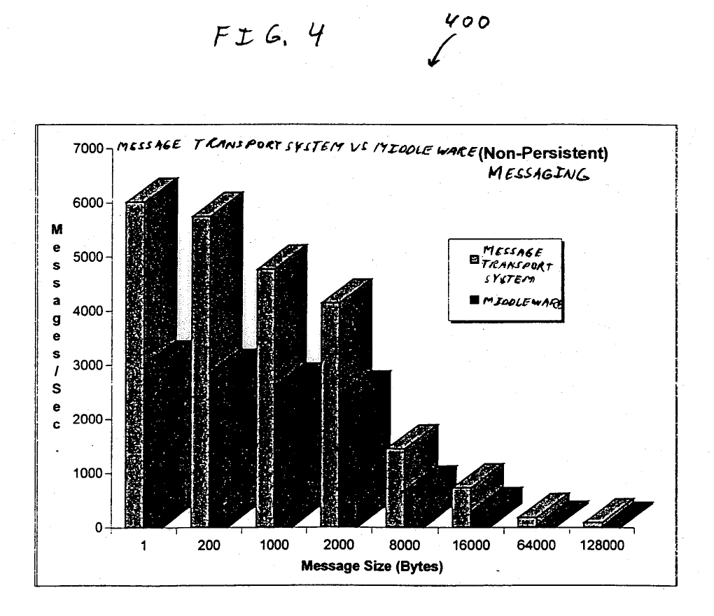

Referring to FIG. 3, on the receiving system 318, the channel queuing system 316 provides a writer subsystem 330, a journal 332, and a reader subsystem 334 for processing the data message, such as processing a persistent data message. The channel queuing system 316 substitutes for the middleware queue manager's 320 method of persistent messaging, reducing overhead and increasing the data message transmission efficiency.

Referring to FIG. 2, the message transport system 200 increases message transmission performance of both persistent messages and non-persistent messages, and is transparent to user applications 212, 224. That is, no changes are needed to the user applications 212, 214 to implement and use the message transport system 200. The user application is relinked to use the channel interface system 210 calls instead of the middleware queuing manager API library 228 calls. Furthermore, no changes are necessary to existing middleware systems to implement the message transport system 200.

The message transport system 200 further increases message transport efficiency by using an alternate protocol to the middleware protocol for the transmission and receipt of data messages which requires less overhead then the protocol used by the middleware. Moreover, the middleware channel is not used by the message transport system 200, and therefore the remote overhead associated with the middleware channel is eliminated. Furthermore, the message transport system 200 replaces some of the middleware queue manager's functions, such as persistent message processing, with its own functions, which further reduces the overhead of the middleware associated with such processing. In addition, for persistent messaging, the message transport system 200 initiates multiple processes for transmitting the data message to multiple target queues, which can then operate in parallel. In contrast, the middleware system uses one process for transmitting the data message to multiple queues.

Referring to FIG. 3, on the sender system 312, the channel interface system 310 includes a configuration file 336 for defining parameters, such as a queue name identifying a queue on the sending system 312 which is to be monitored by channel interface system 310. Data messages sent to the sender system 312 queue are processed by the channel interface system 310 and transmitted to the channel queuing system 316 on the receiver system 318, instead of being processed by the middleware queue manager 320. The configuration file 336 also includes a queue name identifying a queue on the receiving system 318 which is the target of the data message.

Continuing with FIG. 3, the channel interface system 310 includes a store and forward (SAF) file 36 for preserving data messages if a communications link to the receiving system 318 is unavailable. The preserved data messages are transmitted to the receiver system 318 when the communications link to the receiver 318 system is available.

Referring to FIG. 3, an interface channel 326 uses TCP/IP for transmission over many types of communication networks, such as the internet. The data message can be transmitted using wired or wireless transmission. The message transport system 300 can also use User Datagram Protocol (UDP) or other protocols used by middleware for transmitting the data message.

As shown in FIG. 3, the writer subsystem 330 is connected to the channel queuing system channel 326 for receiving data messages from channel interface system 310 on the sender system 312. For non-persistent data messaging, the channel queuing system 316 enables a user application 314 on the sending system 312 to multiplex its data message over the same channel 326 to multiple queue destinations. That is, the channel queuing system 316 can connect the data message to multiple queues. The writer subsystem 330 forwards the data message directly to the targeted queue by invoking a middleware queue manager library 322 command. The queuing manager 320 then processes the data message, and places the data message in the target queue. If the data message is a persistent data message, the writer subsystem 330 instead writes the data message to a file section 340 of the journal 332. The file section 340 is the storage area for data messages for a particular targeted queue.

Continuing with FIG. 3, the journal 332 is located on local storage, such as disk drives, of the receiving system 318, and stores the persistent data message. There is one journal section 340 established within the journal 332 for each target queue. The journal 332 receives the persistent data message from the writer subsystem 330, and is in communication with and read by the reader subsystem 334. The persistent data message remains stored in the journal file section 340 until the middleware queue manager 320 acknowledges that the data message has been received. Each journal file section 340 is managed with a first-in first-out access method (FIFO) by the channel queuing system 316.

Continuing to refer to FIG. 3, the reader subsystem 334 is connected to a target queue section 340 of the journal 332 and is connected to the targeted queue through the middleware queue manager API library 322 commands. The reader subsystem 334 implements persistent messaging by processing data messages from the journal 332 targeted to a single queue. The reader subsystem 334 reads the persistent data message, and forwards a non-persistent data message to the targeted queue. The reader subsystem 334 executes a middleware queue manager API library 322 command to place the data message in the targeted queue. The middleware queue manager 320 processes and passes the data message to the user application 324 on the receiver system 318. The reader subsystem 334 marks the data message in the journal 332 as having been read, and waits for acknowledgment of successful read of data message from middleware queue manager 320. The reader subsystem 334 then marks the data message as acknowledged and proceeds to the next data message in the journal section 340 for the target queue. The data messages in the journal section 340 can be deleted after all data messages in the journal section 340 have been acknowledged and delivered to the user application 324.

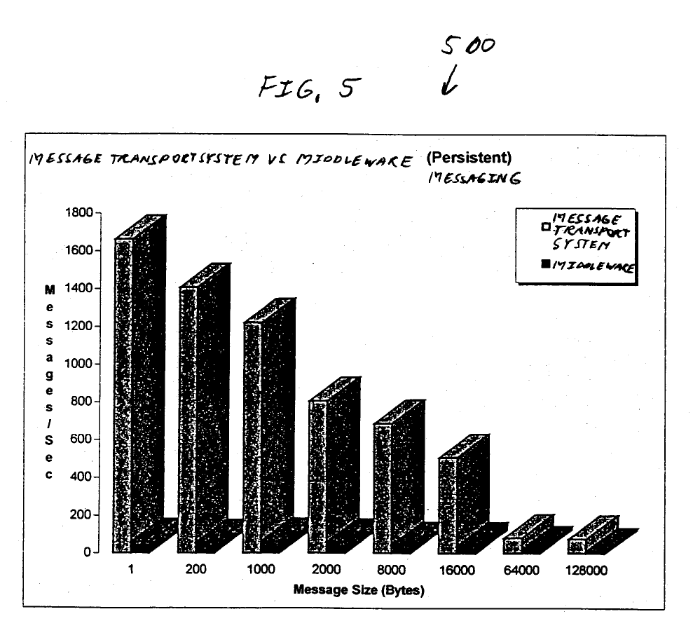

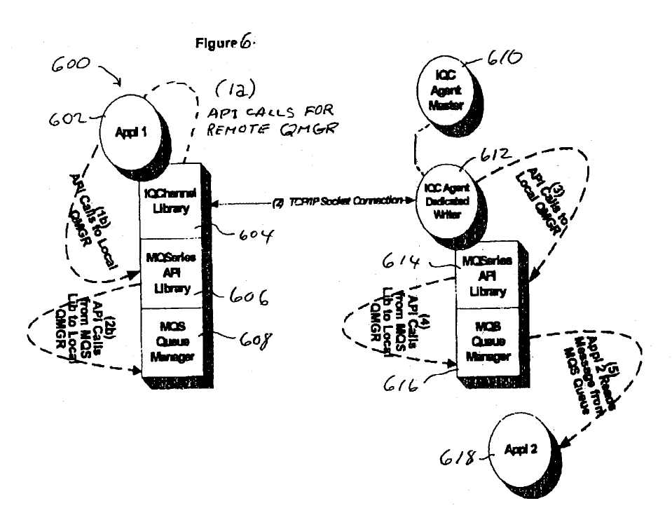

FIG. 4 is a chart 400 showing improvement in non-persistent messaging efficiency from implementing the message transport system 200. FIG. 5 is a chart 500 showing an improvement in persistent messaging efficiency from implementing the message transport system 200.

In another embodiment of the message transport system 200, both sections of the message transport system 200, can be implemented on both the sender system 212, such as a client system, and the receiver system 218, such as a server system in order to increase the transmission speed of the data messages transmitted in both directions between the client system and server system. That is, the channel interface system 210 and the channel queuing system 216, are implemented on both systems, along with another interface channel. In a further embodiment, the middleware queue manager 220 can operate on both the sender system 212 and the receiver system 218 along with the message transport system 200. An interface channel and a middleware channel can also be established between the systems by the message transport system 200 and the middleware system.

The message flow chart of FIG. 6 is presented as an arrangement 600 of functional blocks that shows operation of the message transport system 200 of FIG. 2 for the case of non-persistent message flow from a single source. In the system 200, all MQ API calls are intercepted, and evaluated to determine if they are destined for the local QMGR (Queue Manager) or a remote QMGR that is required for use of the IQChannel. Those MQ API calls that are intended for the local QMGR are passed through to the MQSeries API Library, and those calls intended for the IQChannel are executed by the functions of the IQChannel Library. The arrangement 600 comprises the following functional blocks, namely, a sender application (Appl1) 602, a IQChannel Library 604, an API Library 606, and a Queue Manager 608 which are located on the left side, or message-sending side, of the arrangement 600. Located on the right side, or message-receiving side, of the arrangement 600 are an IQC Agent Master 610, an Agent Dedicated Writer 612, an API Library 614, a Queue Manager 616, and a receiver application (Appl2) 618.

To coordinate the flow of non-persistent data/messages from a single remote application, at the left side of the figure, Appl1 represents the sending application that has been linked with the IQChannel Library. The MQS API function call MQPUT, indicated at 1a, is to the intercepted by the IQChannel Library because this call contains a queue name that is registered in a IQChannel file. The MQS API function call MQPUT, indicated at 1b, is not intercepted by the IQChannel Library, but is to be passed automatically onto the MQS API Library for local processing. The MQS API Library passes the function call, indicated at signal path 2b, to the local Queue Manager for processing. The processing may require that the message be passed on to a standard channel, such as an IBM Standard Channel, or written to a local queue.

As shown on the signal path 2, when the IQChannel Library has prepared the message in a package for transportation, the IQChannel Library sends the message to the appropriate IQC Agent process (writer) on the remote host. The built-in flow control capabilities of the TCP/IP are used to insure that the message is delivered to the IQC Agent process, and the appropriate MQS Return codes are sent back (over the communications channel and through the IQChannel Library) to the originating application Appl1. The IQC Agent process (writer) at the remote computer operates under direction of an IQC Agent Master.

As shown on the signal path 3, the IQC Agent process connects (MQCON) to the specified Queue Manager on the machine running a receiving application Appl2, thereby to open the specified queue (MQOPEN) for write access. A single IQC Agent can handle multiple queue name targets over a single connection. The IQC Agent, as indicated at path 4, makes a MQPUT MQS API function call. The MQS API Library executes the MQPUT call, indicated on path 5, and writes the message non-persistently into the queue. If the MQS queue becomes full, the IQC Agent halts acceptance of messages from the application Appl1 until the queue can accept messages.

For non-persistent message flow and multiple queues, the operation of the invention provides that the IQC Dedicated Writer (Agent) is capable of connecting to multiple queues in order to provide a single input point with multiple outputs to queues. This enables a remote application to multiplex its output signals over the same IQChannel to multiple queue destinations. The data flow is the same as has been described above for the case of the single source, except that the IQC Dedicated Writer is to be connected to multiple queues for Write (MQPUT).

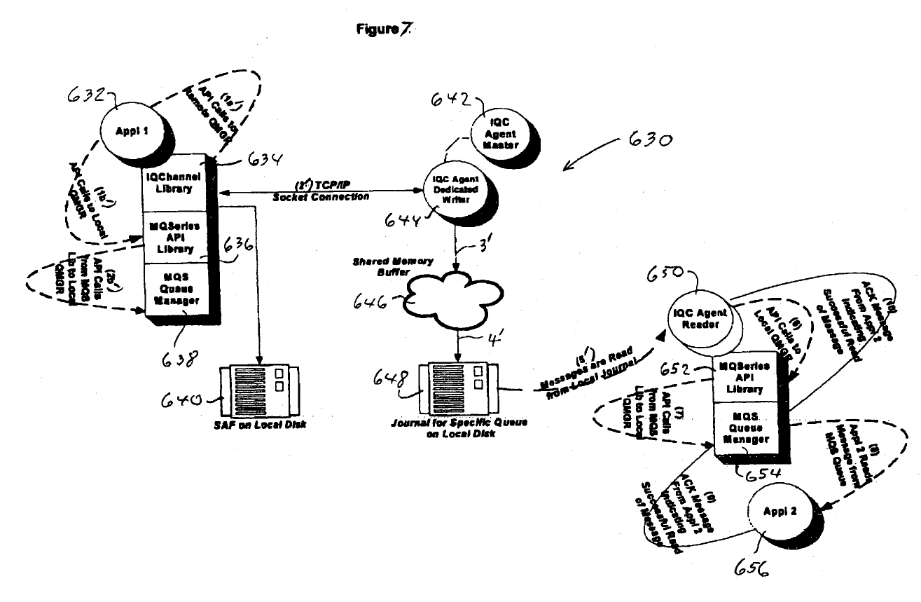

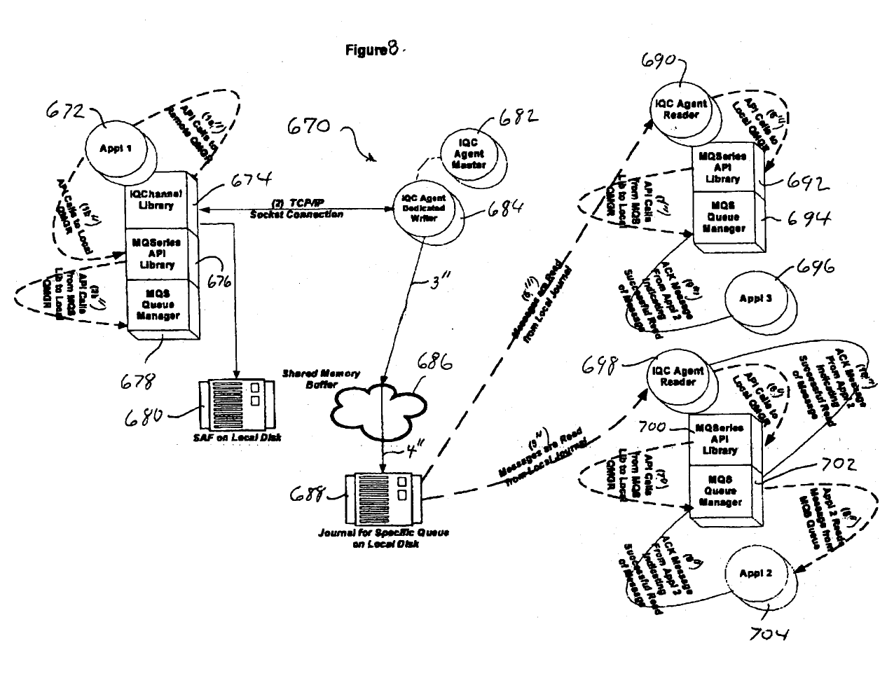

For the case of persistent data/message flow, there is presented in FIG. 7 an arrangement 630 of functional blocks that shows operation of the message transport system 200 of FIG. 2 for coordination of the flow of persistent data/messages. The arrangement 630 comprises the following functional blocks, namely, a sender application (Appl1) 632, a IQChannel Library 634, an API Library 636, a Queue Manager 638, and a storage device (save and forward) 640 that appear on the left side of the figure. Also included in the arrangement 630 are an Agent Master 642, an Agent Dedicated Writer 644, a shared memory buffer 646, a further storage device (journal) 648, an Agent Reader 650, an API Library 652, a Queue Manager 654, and a receiver application (Appl2) 656.

In operation, on path 1a′ the sending application Appl1 is linked with the IQChannel Library. This path carries the MQS API function call MQPUT that is intercepted by the IQChannel Library because this call contains a queue name that is registered in a IQChannel file. The MQS API function call MQPUT, indicated at 1b′, is not intercepted, but it is to be passed automatically onto the MQS API Library for local processing. The MQS API Library passes the function call, indicated at signal path 2b′, to the local Queue Manager for processing. The processing may require that the message be passed on to a standard channel, such as an IBM Standard Channel, or written to a local queue.

As shown on the signal path 2′, when the IQChannel Library has prepared the message in a package for transportation, the IQChannel Library sends the message to the appropriate IQC Agent (Writer) process on the remote host. A flow control mechanism is provided to insure that the message is delivered to the IQC Agent (Writer) process, and the appropriate MQS Return codes are sent back (over the communications channel and through the IQChannel Library) to the originating application Appl1. A connection is also provided between the IQChannel Library and a storage device identified as SAF (save and forward) on Local Disk to enable the saving of a transmitted message until such time as acknowledgment of its reception is noted. If no acknowledgment is received, then there is a retransmission of the message to obtain the mode of transmission providing a persistent data flow.

As shown on the signal path 3′, the IQC Agent (Writer) process writes the message from the application Appl1 to a shared memory section. At the appropriate time, the shared memory section, via path 4′, is flushed to the local journal file on disk (for specific queue), and the file system becomes synchronized. This process provides for the coordination of retransmitted portions of a message for accomplishing the transmission mode of persistent data flow. The IQC Agent (Reader) process, indicated on path 5′, connects (MQCON) to the specified Queue Manager on the machine running the application Appl2, thereby to open the queue (MQOPEN) for write access.

The operation continues on path 6 wherein the IQCC Agent (Reader) process makes a MQPUT MQS API function call. Then, as indicated on path 7, the MQS API Library executes the MQPUT call and writes the message non-persistently into the queue. With reference to path 8, the receiver application Appl2 posts a function call MQGET MQS API to attempt to read a message from the specified queue.

With reference to path 9, the receiver application Appl2 has successfully read a message from the specified queue, and the QMGR sends a message to the IQC Agent's (Reader's) dynamic queue as a notification that the message has been read by the application Appl2. The MQS QMGR delivers the acknowledgment (ACK) message, via path 10, to the IQC Agent (Reader) process to indicate that the application Appl2 process has successfully read the previous message. This causes of the IQC Agent (Reader) to check within the local journal for the next message to be delivered to the QMGR through the paths 6-9.

With reference to FIG. 8, the signal flow graph shows coordination of the flow of persistent data/messages to multiple target queues. This is shown by an arrangement 670 of functional blocks. The presentation of FIG. 8 is substantially the same as that of FIG. 7 with respect to the various functional blocks and the interconnecting paths, except that FIG. 8 shows an additional IQC Agent (Writer) for removing messages from a specific journal and delivering them to a specific queue. The arrangement 670 comprises the following functional blocks, namely, a sender application (Appl1) 672, a IQChannel Library 674, an API Library 676, a Queue Manager 678, and a storage device (save and forward) 680 that appear on the left side of the figure. Also included in the arrangement 670 are an Agent Master 682, an Agent Dedicated Writer 684, a shared memory buffer 686, a further storage device (journal) 688, an Agent Reader 690, an API Library 692, a Queue Manager 694, and a receiver application (Appl3) 696. A further branch of the arrangement 670 connects to the storage device 688 and comprises an Agent Reader 698, an API Library 700, a Queue Manager 702 and a receiver application (Appl2) 704, this branch corresponding in components and the interconnection to the components 650, 652, 654 and 656 of FIG. 7, and also to the branch of FIG. 8 that also connects to the storage device 688 and has the components 690, 692, 694 and 696. The branching out from the storage device 688 enables the processing of the multiple target queues.

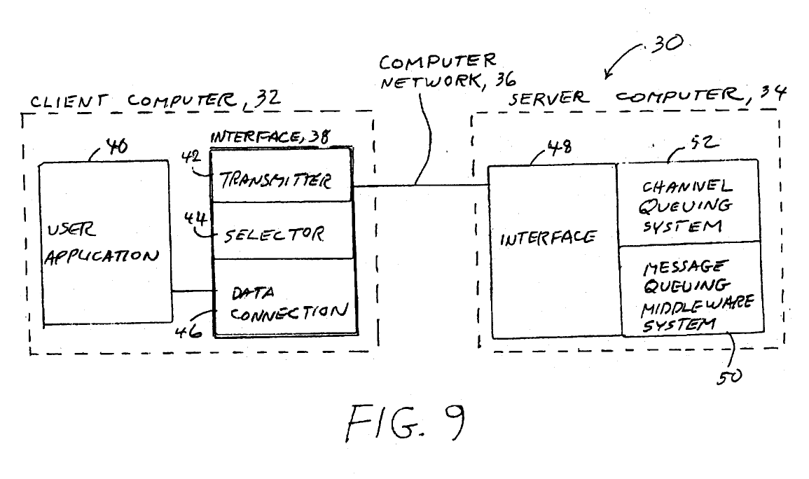

FIG. 9 shows a system 30 for efficient message transport by message queuing middleware, the system 30 demonstrating hardware and computer functions which may be employed in the construction of the system 200 of FIG. 2. The system 30 comprises a client computer 32 and a server computer 34 which are interconnected via a computer network 34. The client computer 32 comprises a channel interface system 38 and employs a user application 40. Included within the channel interface system 38 are a transmitter 42, a selector 44 and a data connection 46. The server computer 34 comprises an interface 48 for receiving a data message transmitted via the computer network 36, a message queuing middleware system 50, and a channel queuing system 52 for receiving the data message from the interface 48 and for distributing the data message to the message queuing middleware system 50. In the client computer 32, the data connection 46 is operative to provide a connection for data between the user application 40 and the channel interface system 38. The selector 44 associates a data message with the channel interface system 38, and the transmitter 42 transmits the data message via the computer network 36 to the interface 48 of the server computer 34.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A system for efficient message transport by message queuing middleware, comprising:
a client computer, wherein the client computer comprises:
at least one user application;
a channel interface system comprising:
a data connection to the at least one user application;
a selector for associating a data message with a channel interface system;
a transmitter for transmitting the data message via a computer network;
a server computer having an interface for receiving the data message via the computer network, the server computer comprising:
a message queuing middleware system; and
a channel queuing system for receiving the data message and distributing the data message to the message queuing middleware system.

2. A method for operation of a message transport system having a sender of a message and a receiver of the message, wherein the sender comprises a sender computer having a sender queue manager and operating under a sender application linked to both a sender channel library and a sender application programming interface (API) library, and the receiver comprises a receiver computer operating under a receiver application and providing the functions of a receiver queue manager and a receiver channel agent dedicated writer (AGENT) that are linked to a receiver API library, the method comprising the steps of:
by means of the sender application, applying API calls for a remote queue manager to the sender channel library and applying API calls for a local queue manager to the sender API library;
applying API calls from the sender API library to the sender queue manager;
sending a message from the sender channel library to the receiver AGENT;
directing API calls for the local queue manager from the receiver AGENT to the receiver API library; and
directing the receiver queue manager to receive API calls from the from the receiver API library and to read
a message from a received queue to the receiver application.

3. A method according to claim 2 wherein, in said sending step, there is a non-persistent flow of data.

4. A method according to claim 2 further comprising a step of storing messages from the sender channel library for possible retransmission to provide, for the sending step, a transmission mode having persistent data flow.

5. A method according to claim 4 further comprising a step of operating the receiver computer with a further memory for coordinating retransmitted sections of a message to provide, for the sending step, a transmission mode having persistent data flow.

6. A method according to claim 2 further comprising a step, by the receiver queue manager, of acknowledging a successful reading of a transmitted message to provide, for the sending step, a transmission mode having persistent data flow.
